(19) United States
(12) Patent Application Publication
(10) Pub. No.: US 2016/0266915 A1
(43) Pub. Date: Sep. 15, 2016

(54) Systems and Methods for Providing an Emulation of a Computer Product

(71) Applicants: Giovanni Morelli, Mississauga (CA); Brandon Cowen, Mississauga (CA); Marian Dan, Mississauga (CA)

(72) Inventors: Giovanni Morelli, Mississauga (CA); Brandon Cowen, Mississauga (CA); Marian Dan, Mississauga (CA)

(21) Appl. No.: 15/066,179

(22) Filed: Mar. 10, 2016

Related U.S. Application Data
(60) Provisional application No. 62/130,879, filed on Mar. 10, 2015.

(51) Int. Cl. G06F 9/455; H04L 29/06

(52) U.S. Cl. CPC G06F 9/455; H04L 67/42

(57) ABSTRACT

Systems, methods and computer program products for providing an emulation of a computer product are disclosed. A request for an access link for the computer product is received from a client device and the access link is generated and provided to the client device. The access link configures the client device to generate an emulation request for the computer product when the link is selected. The emulation request is sent to an emulation system. The emulation system identifies from the emulation request the computer product and remote resources required to emulate the computer product. At least one emulator server is selected, and the required remote resources are provided by the selected emulator servers. The requested emulation is initiated using the resources provided by the selected emulator servers.

### RELATED APPLICATIONS

This application claims priority from the U.S. patent application No. 62/130,879, filed Mar. 10, 2015 entitled “SYSTEMS AND METHODS FOR PROVIDING AN ACCESS LINK SELECTABLE TO INITIATE AN EMULATION AT A REMOTE EMULATOR SERVER”, the disclosure of which is incorporated herein, in its entirety, by reference.

### FIELD

The described embodiments relate to systems, methods, and computer program products for providing an emulation of a computer product, and in particular for initiating an emulation of the computer product at a remote emulator server.

### BACKGROUND

An emulator operates to imitate a computer product in an emulation session. The imitated computer product can be provided to a client device. The computer product can be a computer system, an operating environment, a software application, or one or more hardware and software components. The emulator system facilitates the emulation session by translating and processing instructions received from the client device into a format compatible with the emulated computer product.

Providing to the client device an access link selectable to initiate an emulation at a remote emulator server may improve operation of the emulator system.

### SUMMARY

The embodiments described herein provide in an aspect a system and method for providing an access link selectable to initiate an emulation at a remote emulator server. In some embodiments the system can comprise a processor configured to receive a request from a client device for an access link selectable to initiate an emulation of a computer product. The processor can be further configured to generate and provide the access link to the client device, the access link configured to include data for triggering the client device to generate an emulation request in response to the access link being selected, the emulation request including computer product data defining the computer product and client device data defining one or more characteristics of the client device at a time the access link is selected. The processor can be further configured to receive the emulation request from the client device and initiate an emulation session based on the computer product data and the client device data.

The embodiments described herein provide in an aspect a method for providing an emulation of a computer product. The method includes receiving a link request for an access link from a client device, the link request including an identification of at least one computer product to be emulated. The method also includes generating the access link to include client device instructions for configuring a client device to, in response to a selection of the access link at the client device, generate an emulation request for initiating an emulation session for the at least one computer product, the emulation request identifying client device data associated with the client device, the client device data including at least one client resource identifier, each client resource identifier defining a resource kind present at the client device, and the emulation request being generated to enable an emulation control server to determine the at least one computer product for the emulation session from computer product data associated with the emulation request; identify remote resource kinds required to provide the emulation session based on the client device data and the at least one computer product, the remote resource kinds including at least one of a hardware resource kind and a software resource kind, the remote resource kinds being providable remotely from the client device for the emulation session by, for each remote resource kind, providing a corresponding remote resource instance; select at least one emulator server to provide the identified remote resource kinds; and initiate the requested emulation session by instructing the selected at least one emulator server to provide the identified remote resource kinds by providing the corresponding remote resource instance for each identified remote resource kind on a particular emulator server of the selected at least one emulator server; and provide the emulation request to the emulation control server. The method also includes providing the access link to the client device.

In some embodiments, the access link is provided to the client device to enable repeated selection of the access link at the client device; and the client device instructions enable the client device to generate the emulation request in response to each selection of the access link at the client device.

In some embodiments, the client device instructions enable the client device to generate a first emulation request for initiating a first emulation session in response to a first selection of the access link; and generate a second emulation request for initiating a second emulation session in response to a second selection of the access link; where the first emulation request enables the emulation control server to initiate the first emulation session using a first at least one resource instance, the first at least one resource instance including a first set of resource instances; the second emulation request enables the emulation control server to initiate the second emulation session using a second at least one resource instance, the second at least one resource instance including a second set of resource instances; and the first set of resource instances and the second set of resource instances are different.

In some embodiments, the client device data identified by the first emulation request includes a first set of client device data values; and the client device data identified by the second emulation request includes a second set of client device data values, the second set of client device data values being different from the first set of client device data values.

In some embodiments, the first emulation request enables the emulation control server to identify a first set of remote resource kinds required to provide the first emulation session based on the first set of client device data values; the second emulation request enables the emulation control server to identify a second set of remote resource kinds required to provide the second emulation session based on the second set of client device data values; and the first set of remote resource kinds and the second set of remote resource kinds are different.

In some embodiments, the access link is provided to the client device in a link format enabling the client device to permanently store the access link and the client device instruction at the client device to enable the repeated selection of the access link.

In some embodiments, the client device instructions include request instructions for configuring the client device to, in response to the selection of the access link at the client device trigger collection of at least some of the client device data at the client device, the at least some of the client device data that is collected identifying a resource state of at least one of the client resource identifiers, each resource state indicating whether a resource kind present at the client device is available for use in providing the emulation; and to generate the emulation request to include the at least some of the client device data in the emulation request provided to the emulation control server.

In some embodiments, the client device data includes operational device data defining operational characteristics of the client device, the operational characteristics comprising at least one resource state characteristic, each resource state characteristic corresponding to one of the client resource identifiers and defining a state of the resource kind identified by that client resource identifier; and the emulation request enables the emulation control server to identify the remote resource kinds required to provide the emulation session by identifying product required resource kinds required for the emulation session using the computer product data; identifying local resource kinds by identifying the resources kinds present at the client device that are available for the emulation session using the operational device data; and identifying the remote resource kinds based on the product required resource kinds and the local resource kinds.

In some embodiments, the client device instructions include request instructions for configuring the client device to, collect the client device data, and store the collected client device data; and the emulation request identifies the stored client device data as the client device data associated with the client device.

In some embodiments, the request instructions include storage instruction for configuring the client device to store the collected client device data at a remote database; and data collection instructions for configuring the client device to trigger collection of updated client device data at the client device, the updated client device data identifying a change in at least one of the at least one client resource identifiers and a resource state of the at least one client resource identifiers, each resource state indicating whether a resource kind present at the client device is available for use in providing the emulation.

In some embodiments, the method also includes providing a web interface including a plurality of computer product identifiers, each computer product identifier identifying a computer product that is emulatable through the emulation control server;

and the at least one computer product to be emulated is identified in the link request by a selection of the computer product identifiers from the plurality of computer product identifiers, the selected computer product identifiers corresponding to the at least one computer product to be emulated.

In some embodiments, the method also includes identifying at least one of the client device and a user associated with the client device; identifying a list of permissible computer products for the identified at least one of the client device and the user; and the plurality of computer product identifiers included in the web interface is selected from the list of permissible computer products.

In some embodiments, the method also includes authenticating at least one of the client device and a user associated with the client device prior to providing the access link to the client device.

The embodiments described herein provide in an aspect a system for providing an emulation of a computer product. The system can include an emulation control server for communicating with a client device over a network; and at least one emulator server coupled to the emulation control server. The emulation control server is configured to receive a link request for an access link from the client device, the request including an identification of at least one computer product to be emulated; generate the access link to include client device instructions for configuring the client device to, in response to a selection of the access link at the client device, generate an emulation request for initiating an emulation session for the at least one computer product, the emulation request identifying client device data associated with the client device, the client device data including at least one client resource identifier, each client resource identifier defining a resource kind present at the client device; provide the access link to the client device over the network; receive the emulation request from the client device in response to the selection of the access link at the client device; determine the at least one computer product for the emulation session from computer product data associated with the emulation request; identify remote resource kinds required to provide the emulation session based on the client device data and the at least one computer product, the resource kinds including at least one of a hardware resource kind and a software resource kind, the remote resource kinds being providable remotely from the client device for the emulation session by, for each remote resource kind, providing a corresponding remote resource instance; select at least one emulator server to provide the identified remote resource kinds; and initiate the requested emulation by transmitting an initiation instruction to each of the selected at least one emulator server to provide at least one particular resource kind from the identified remote resource kinds by providing the corresponding remote resource instance for that at least one particular resource kind, wherein for each emulator server of the selected at least one emulator server the initiation instruction indicates at least one particular resource kind from the identified resource kinds for that emulator server to provide. Each emulator server can be configured to provide a resource instance of the at least one particular resource kind for that emulator server to initiate the requested emulation session for the client device.

In some embodiments, the emulation control server is configured to generate the access link to enable repeated selection of the access link at the client device, and wherein the client device instructions enable the client device to generate the emulation request in response to each selection of the access link at the client device.

In some embodiments, the emulation control server is configured to receive from the client device a first emulation request for initiating a first emulation session in response to a first selection of the access link at the client device; initiate the first emulation session using a first at least one resource instance, the first at least one resource instance including a first set of resource instances; receive from the client device a second emulation request for initiating a second emulation session in response to a second selection of the access link at the client device; and initiate the second emulation session using a second at least one resource instance, the second at least one resource instance including a second set of resource instances; and the first set of resource instances and the second set of resource instances can be different. In some embodiments, the client device data identified by the first emulation request includes a first set of client device data values; and the client device data identified by the second emulation request includes a second set of client device data values, the second set of client device data values being different from the first set of client device data values.

In some embodiments, the emulation control server is configured to identify a first set of remote resource kinds required to provide the first emulation session based on the first set of client device data values; identify a second set of remote resource kinds required to provide the second emulation session based on the second set of client device data values; and the first set of remote resource kinds and the second set of remote resource kinds can be different.

In some embodiments, the emulation control server is configured to generate the access link in a link format enabling the client device to permanently store the access link.

In some embodiments, the emulation control server is configured to generate the access link so that the client device instructions include request instructions for configuring the client device to, in response to the selection of the access link at the client device: trigger collection of at least some of the client device data at the client device, the at least some of the client device data that is collected identifying a resource state of at least one of the client resource identifiers, each resource state indicating whether a resource kind present at the client device is available for use in providing the emulation; and generate the emulation request to include the at least some of the client device data in the emulation request.

In some embodiments, the client device data in the received emulation request includes operational device data defining operational characteristics of the client device, the operational characteristics comprising at least one resource state characteristic, each resource state characteristic corresponding to one of the client resource identifiers and defining a state of the resource kind identified by that client resource identifier; and the emulation controller server is configured to identify the remote resource kinds required to provide the emulation session by: identifying product required resource kinds required for the emulation session using the computer product data; identifying local resource kinds by identifying the resources kinds present at the client device that are available for the emulation session using the operational device data; and identifying the remote resource kinds based on the product required resource kinds and the local resource kinds.

In some embodiments, the emulation control server is configured to generate the access link so that the client device instructions include request instructions for configuring the client device to: collect the client device data, store the collected client device data; and identify in the emulation request the stored client device data as the client device data associated with the client device.

In some embodiments, the emulation control server is configured to generate the access link so that the request instructions include storage instruction for configuring the client device to store the collected client device data at a remote database; and data collection instructions for configuring the client device to trigger collection of updated client device data at the client device, the updated client device data identifying a change in at least one of the at least one client resource identifiers and a resource state of the at least one client resource identifiers, each resource state indicating whether a resource kind present at the client device is available for use in providing the emulation.

In some embodiments, the emulation control server is further configured to provide a web interface including a plurality of computer product identifiers, each computer product identifier identifying a computer product that is emulatable through the emulation control server; and receive the link request using through the web interface, wherein the at least one computer product to be emulated is identified in the link request by a selection of the computer product identifiers from the plurality of computer product identifiers, the selected computer product identifiers corresponding to the at least one computer product to be emulated.

In some embodiments, the emulation control server is further configured to: identify at least one of the client device and a user associated with the client device;

identify a list of permissible computer products for the identified at least one of the client device and the user; and select the plurality of computer product identifiers to be included in the web interface from the list of permissible computer products.

In some embodiments, the emulation control server is further configured to authenticate at least one of the client device and a user associated with the client device prior to providing the access link to the client device.

The embodiments described herein provide in an aspect a non-transitory computer-readable storage medium having stored thereon a plurality of instructions are stored, the instructions for configuring a processor to perform a method of providing an emulation of a computer product. The method can include receiving a link request for an access link from a client device, the link request including an identification of at least one computer product to be emulated; generating the access link to include client device instructions for configuring a client device to, in response to a selection of the access link at the client device: generate an emulation request for initiating an emulation session for the at least one computer product, the emulation request identifying client device data associated with the client device, the client device data including at least one client resource identifier, each client resource identifier defining a resource kind present at the client device, and the emulation request being generated to enable an emulation control server to: determine the at least one computer product for the emulation session from computer product data associated with the emulation request; identify remote resource kinds required to provide the emulation session based on the client device data and the at least one computer product, the remote resource kinds including at least one of a hardware resource kind and a software resource kind, the remote resource kinds being providable remotely from the client device for the emulation session by, for each remote resource kind, providing a corresponding remote resource instance; select at least one emulator server to provide the identified remote resource kinds; and initiate the requested emulation session by instructing the selected at least one emulator server to provide the identified remote resource kinds by providing the corresponding remote resource instance for each identified remote resource kind on a particular emulator server of the selected at least one emulator server; and provide the emulation request to the emulation control server; and providing the access link to the client device.

### DETAILED DESCRIPTION OF DRAWINGS

Several embodiments of the present invention will now be described in detail with reference to the drawings, in which:

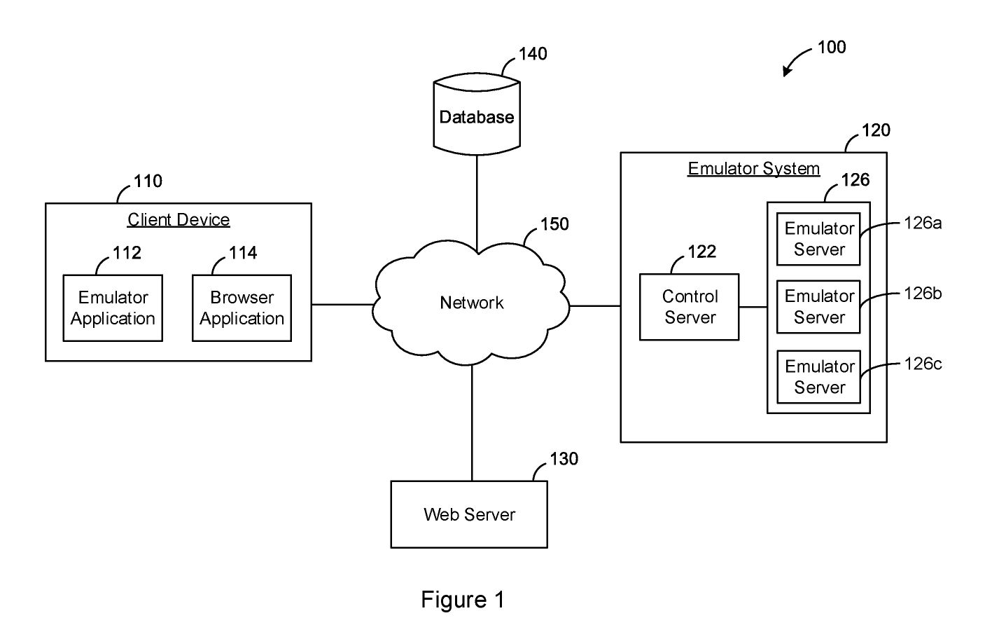

FIG. 1 is a block diagram illustrating an emulator system in communication with other components, in accordance with an example embodiment; and

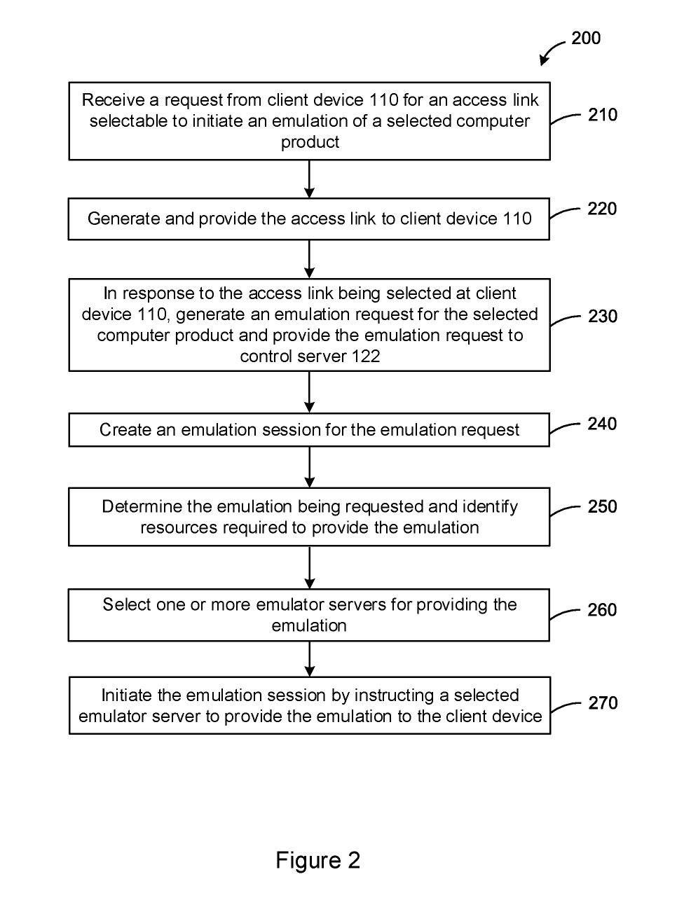

FIG. 2 is a flowchart illustrating a process for providing a client device with an emulation of a computer product, in accordance with an example embodiment.

The drawings, described below, are provided for purposes of illustration, and not of limitation, of the aspects and features of various examples of embodiments described herein. The drawings are not intended to limit the scope of the teachings in any way. For simplicity and clarity of illustration, elements shown in the figures have not necessarily been drawn to scale. The dimensions of some of the elements may be exaggerated relative to other elements for clarity. It will be appreciated that for simplicity and clarity of illustration, where considered appropriate, reference numerals may be repeated among the figures to indicate corresponding or analogous elements or steps.

### DETAILED DESCRIPTION OF EXEMPLARY EMBODIMENTS

The embodiments of the systems, processes, and methods described herein may be implemented in hardware or software, or a combination of both. Alternatively, these embodiments may also be implemented in computer programs executed on programmable computers each comprising at least one processor (e.g., a microprocessor), a data storage system (including volatile and non-volatile memory or storage elements), at least one input device, and at least one output device. For example and without limitation, the programmable computers (referred to below as computing devices) may be a personal computer, laptop, personal data assistant, cellular telephone, smart-phone device, tablet computer, wireless device, etc. For any software components, program code is applied to input data to perform the functions described herein and generate output information. The output information is applied to one or more output devices, in known fashion.

Each software component or program may be implemented in a high level procedural or object oriented programming or scripting language to communicate with a computer system. However, the programs can be implemented in assembly or machine language, if desired. In any case, the language may be a compiled or interpreted language. Each such computer program is preferably stored on a storage media or a device (e.g., ROM (read-only memory)) readable by a general or special purpose programmable computer, for configuring and operating the computer when the storage media or device is read by the computer to perform the procedures described herein. The subject system may also be considered to be implemented as a non-transitory computer-readable storage medium, configured with a computer program, where the storage medium so configured causes a computer to operate in a specific and predefined manner to perform the functions described herein.

Furthermore, the processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, this description and the drawings are not to be considered as limiting the scope of the embodiments described herein in any way, but rather as merely describing the implementation of the various embodiments described herein.

The various embodiments described herein generally relate to a system and related methods for providing an emulation of a computer product for a client device. The various embodiments of the systems and methods described herein may generate an access link including client device instructions that enable the access link to be selectable to initiate an emulation of a computer product at a remote emulator server. The emulation of the computer product may then be provided to the client device to allow a user of the client device.

In embodiments of the systems and methods described herein, the access link provided to the client device may be provided in a link format allowing the access link to be resident at the client device (i.e. to be stored on a memory of the client device). This may provide an emulation of a computer product to a user of the client device seamlessly, without requiring the user to access an emulator application prior to selecting the access link. The access link may be provided in a format such as an icon or shortcut for example that appears similar to the format of links or icons for computer products resident on the client device. Accordingly, a user of the client device may not perceive that the computer product is being emulated remotely, because the user's experience in selecting the access link may be similar to selecting links for other computer products installed on the client device. The access link may also be repeatedly selectable to allow a user of the client device to initiate different emulation sessions for emulating the computer product.

As used herein, the terms resource and resources may apply generally to refer to various computer components (hardware or software) including both emulated and non-emulated computer components. The term resource kind may refer to a particular type of resource such as a CPU, GPU, a CAD software application for example. Resource kind or kinds may also refer to resource types at varying levels of granularity, such as specifying different CPU speeds, or varying levels of functionality provided by a software resource (e.g. read-only functions, read/write functions etc.).

A resource instance may refer to a particular instantiation or example or occurrence of a resource kind. For instance, if a particular device had two CPUs of the same CPU resource kind, each CPU would be an instance of that CPU resource kind. If, for example, two substantially identical word processing applications were available to a client device 110, each copy of the word processing application may be referred to as an instance of that word processing application resource kind.

### FIG. 1

Reference is made to FIG. 1, which illustrates a block diagram 100 of an emulator system 120 in communication with other components in accordance with an example embodiment.

As shown in FIG. 1, emulator system 120 may communicate with a client device 110, a web server 130, and a database 140 over a network 150. Similarly, each of client device 110, web server 130, and database 140 may also communicate with each other over network 150. The network 150 may include, for example, a mobile network, the internet, or a virtual emulator network.

### Client Device 110

Client device 110 may generally be any computing device capable of network communication. For example, client device 110 may be a personal computer, laptop, personal data assistant, cellular telephone, smart-phone device, tablet computer, wireless device, etc. It will be understood that, for ease of exposition, only one client device 110 is illustrated, but two or more client devices may be used.

Client device 110 can include resources present at the client device 110. The resources present at the client device 110 may generally be referred to as local resources.

The local resources at client device 110 can include software and hardware resources. For example, as illustrated in FIG. 1, the software resources may include an emulator application 112 and a browser application 114. Browser application 114 may be executed on client device 110 for providing a browser with which a user may access network 150.

Emulator application 112 can enable compatibility between client device 110 and emulator system 120. For example, emulator application 112 may enable client device 110 to properly interface with any software and hardware components that may be provided at emulator system 120. In some embodiments, emulator application 112 may operate in the background on client device 110. For instance, many operations of emulator application 112 may be transparent (i.e. substantially imperceptible) to a user of the client device 110.

Emulator application 112 may collect information regarding client device 110. In some example embodiments, emulator application 112 may collect the client device information in the background without being prompted to do so by a user of the client device 110. For example, emulator application 112 may record client resource identifiers defining the software and hardware resources available at client device 110, and provide the client resource identifiers to emulator system 120 for processing, or to database 140 for storage. The information collected regarding the client device 110 may be referred to as client device data. This client device data may include at least one of these client resource identifiers.

The client device data may also include operational device data defining operational characteristics of the client device 110. Emulator application 112 may further track operational characteristics of client device 110. Operational characteristics may include, for example, operational capabilities, parameters, status, availability, capacity, operational load, computational efficiency, computational performance, network throughput, bandwidth availability, and other similar factors corresponding to the operational characteristics of client device 110 or any of its resources. Emulator application 112 may forward operational data defining the operational characteristics of client device 110 to emulator system 120 for processing, or database 140 for storage.

The hardware resources provided on client device 110 may include any known hardware resources for operating client device 110. For example, the hardware resources may include an interface module for receiving and transmitting data (e.g., a USB (universal serial bus) port, one or more peripheral ports, etc.), a processor component (e.g., a CPU (central processing unit)), a storage or memory component (e.g., RAM (random access memory)), a navigation module (e.g., a GPS (global positioning system)), a multimedia module (e.g., a sound card, a video card, etc.), a communication module for providing communication with external components or devices (e.g., via radio-frequency, wireless, Bluetooth™ communication, etc.), one or more user interface components (e.g., a touch screen, a keyboard, a display, etc.), or other modules for providing additional features (e.g., a gyroscope, etc.).

It will be understood that other software or hardware resources may be provided on client device 110.

### Database 140

Database 140 can store and provide various data associated with any of client device 110, users associated with client device 110, web server 130, and emulator system 120. For example, database 140 can store information associated with certain computer products to be emulated, such as required-resource data defining the software and hardware resources required for emulating computer products. Database 140 may also store client device data and emulator server data defining the resources and operational characteristics of client device 110 and emulator system 120, respectively; authentication data for identifying and authenticating users or client devices; user account data defining a user's access privileges or service subscriptions for emulator system 120, user preferences with respect to emulations provided by emulator system 120, history of usage of emulator system 120, etc.

Database 140 may be accessible over the network 150 by any of client device 110, web server 130, and emulator system 120. It will be appreciated that in some embodiments, database 140 may be provided as part of emulator system 120. It will further be appreciated that other databases may be provided in addition to, or in lieu of, database 140. For example, in some embodiments, control server 122 may include a control server database that can provide the same or similar functionality as database 140.

### Web Server 130

Web server 130 can generally be used to host a website or one or more webpages that act as a web interface or portal to emulator system 120. In some embodiments, web server 130 may be provided as part of emulator system 120. For example, control server 122 may include web server 130, and therefore also host the website. In some embodiments, control server 122 may be configured to provide some or all of the functionalities of web server 130.

The website may include one or more user interfaces for registering and authenticating users; providing a listing of computer products that emulator system 120 is capable of emulating; receiving subscription requests for a computer product that emulator system 120 is capable of emulating; providing a listing of computer products for which a user has subscribed; receiving user requests for an access link for one or more computer products; receiving user requests for initiating an emulation session, etc. User requests for initiating an emulation session may be referred to as emulation requests.

Client device 110 may display the website using browser application 114, and web server 130 providing the displayed website may receive registration data, subscription data, emulation request data, etc. from client device 110 via the website.

The web interface provided by web server 130 may include a plurality of computer product identifiers. Each computer product identifier may identify a computer product that is emulatable through the emulation control server. A user of the client device 110 may interact with the web interface to select one of the computer product identifiers and request an access link for the computer product associated with the selected computer product identifier. The web server 130 may receive this link request and forward it to emulator system 120, which can in turn generate the corresponding access link and provide it to the client device 110.

This web interface may operate similar to a marketplace for downloading applications for installation on a client device 110. Rather than providing an application that is downloaded and installed onto the client device 110, an access link can be provided to the client device 110. The access link may allow a user of the client device 110 to generate an emulation request for an emulation of the computer product associated with the access link. The user's experience with the emulation of the computer product using the access link may be similar to using an application that is downloaded and installed on client device 110. However, the emulated computer product whose functionality is being provided to the user of the client device 110 is being provided remotely by the emulation system 120.

In some embodiments, web server 130 may forward emulation requests received from client device 110 to emulator system 120 for initiating a corresponding emulation session. In response to receiving an emulation request, emulator system 120 may implement the emulation request.

### Emulator System 120

Emulator system 120 may include one or more components for providing an emulation of a computer product based on an emulation request received from client device 110. The components may include an emulation control server 122 and one or more remote emulator servers 126.

Although emulator system 120 is shown to include multiple emulator servers 126a, 126b, and 126c, in some embodiments, emulator system 120 may include more or fewer emulator servers 126. For example, emulator system 120 may include one, two, four, five, or more emulator servers 126. Further, although control server 122 and emulator servers 126 are shown as separate computer servers, it will be understood that in some embodiments, control server 122 and one or more emulator servers 126 may be provided as one computer server. It will be further understood that any one of control server 122 and each emulator server 126 may be provided as two or more computer servers.

Control server 122 and each emulator server 126 can include a processing component and a memory component. For example, control server 122 may include a control processor and each emulator server 126 may include a respective emulator processor. It will be understood that in some embodiments, the control processor and an emulator processor may be provided as the same processor. In other embodiments, the control processor or an emulator processor may be provided as two or more processors.

Control server 122 can generally operate to create one or more emulation sessions in response to receiving an emulation request; select one or more emulator servers for providing the emulation session; and initiate, track, and manage, each created session based on a session identifier.

Emulator servers 126 can generally operate to provide an emulation of a computer product based on the emulation request received from client device 110. To do so, emulator servers 126 may provide or make available one or more hardware or software resources required for providing an emulation session.

### FIG. 2

Reference is now made to FIG. 2, which is a flowchart illustrating an example process 200 for providing client device 110 with an access link selectable to initiate an emulation of a particular computer product at one or more emulator servers 126, in accordance with an example embodiment.

### Step 210

At 210, a user can request an access link to be provided to client device 110. The user may request the access link by submitting a request via a web interface of a website hosted on web server 130. The user may access the web interface using browser application 114. The user may be required to provide authentication information to access the web interface for requesting an access link. Web server 130 may access user account data stored in database 140 to identify and authenticate the user.

The web server 130 may provide the web interface to include a plurality of computer product identifiers, such as a series or icons or a list of compute product identifiers for example. Each computer product identifier may identify a computer product that is emulatable through the emulation control server 122. The user may identify the at least one computer product to be emulated in the link request by selecting one or more of the computer product identifiers from the web interface.

In some embodiments, the web server 130 and/or emulator system 120 may identify at least one of the client device 110 and a user associated with the client device 110. The web server 130 and/or emulator system 120 may identify a list of permissible computer products for the identified at least one of the client device and the user. For instance, the permissible computer products may be products subscribed to by the user or products whose emulation can be provided using client device 110. The plurality of computer product identifiers included in the web interface can then be selected from the list of permissible computer products.

As explained above, the web interface may provide a listing of computer products that emulator system 120 can provide to client device 110 during an emulation session. For example, the web interface may provide a listing of applications such as Adobe Photoshop™, Microsoft Word™, Apple Aperture™, etc. The user may request for an access link for one or more of the listed computer products to be provided to client device 110. To do so, the user may drag an icon representing a particular computer product of the listing of computer products from the web interface into a folder, or onto the desktop, of client device 110, or may click on the name or icon of a particular computer product. For example, a user may request an access link to be provided by right clicking on an icon for, or name of, a computer product and selecting “provide access link” from a generated drop down menu.

### Step 220

At 220, the web server 130 and/or emulation control server 122 can receive the link the link request for an access link generated at 210 by client device 110. The link request generally includes an identification of at least one computer product to be emulated. In response to receiving the request from the user for an access link for a particular computer product, web server 130 can generate and provide the access link to client device 110.

In some example embodiments, the web server 130 and/or emulation control server 122 may authenticate at least one of the client device 110 and a user associated with the client device 110 prior to providing the access link to the client device. For example, this authentication may be performed using authentication data stored in database 140. The user and/or client device 110 may be authenticated to identify permissible computer products for that user and/or client device 110 (e.g. products to which they subscribe, or for which they have purchased an access link). In some cases, the user of client device 110 may be prompted to purchase the requested access link if the access link corresponds to a computer product not yet permissible for that user.

The access link may be provided to client device 110 as, for example, an icon representing the computer product, a URL, a shortcut defined by the user, etc. For example, client device 110 may be a laptop computer running a Windows 7™ operating system. In this case, the access link may be provided as an icon in a file folder or on the Windows 7 desktop, taskbar, start menu, etc.

In another example, the access link may be provided to client device 110 via a web interface. For example, the access link may be provided via a website hosted by web server 130 which the user can access using browser application 114. The website may provide a web interface displaying the access link along with any other access links previously requested by the user. In some examples, the access link may be provided both on the client device 110 and via a web interface.

The access link can be configured to include client device instructions including request instructions for generating an emulation request in response to the access link being selected. The request instructions can specify emulation data for the emulation request such as, for example, an address for control server 122, an address for one or more emulator servers 126 selected for providing the emulation, an identifier of the computer product associated with the access link, an identifier associated with client device 110 or the user, etc. In some examples, the request instructions may also specify data for triggering actions at client device 110, such as launching emulator application 112 to generate the emulation request based on the emulation data, collecting various types of client device data to be provided as part of the emulation request, etc.

The access link can be provided to the client device 110 to enable repeated selection of the access link at the client device. The client device instructions may enable the client device 110 to generate the emulation request in response to each selection of the access link at the client device 110. In some cases, the access link may be provided to the client device 110 in a link format enabling the client device 110 to permanently store the access link. Permanently storing the access link and corresponding client device instructions at the client device 110 may enable the repeated selection of the access link. For instance, as mentioned above, the access link may be provided as an icon that can be repeatedly selectable by a user of the client device 110. As a result, the user experience at client device 110 when requesting an emulation of the computer product using the access link may be similar to requesting a computer product that is resident on the client device 110.

In some examples, instead of including such request instructions, the access link may include an address for obtaining the request instructions, such as the address of database 140 in which the request instructions can be stored.

### Step 230

At 230, in response to the user selecting the access link provided at 220, an emulation request for initiating an emulation session for the computer product associated with the access link may be generated and provided to control server 122. The access link generated and provided to the client device 110 at step 220 may include client device instructions for configuring the client device 110 to generate the emulation request in response to a selection of the access link at the client device 110.

The emulation request generated by client device 110 may identify client device data associated with the client device. The client device data can include at least one client resource identifier that defines a resource kind present at the client device 110.

In some examples, selecting the access link may trigger client device 110 to launch emulator application 112, which may generate the emulation request based on the request instructions. The generated emulation request can include the emulation data specified by the request instructions, such as the identifiers associated with the computer product to be emulated, the client device 110, or the user.

Selecting the access link may further trigger client device 110 to collect various types of client device data to include as part of the emulation request. The client device 110 may include at least some of the client device data in the emulation request provided to the emulation control server 122.

In some embodiments, the client device data can include authentication data for authenticating client device 110 or one or more users associated with client device 110; resource identifiers defining the software and hardware resources available at client device 110; operational data indicating the operational characteristics of client device 110 and its resources; a geographic location of client device 110; the local time at the geographic location of client device 110, etc.

The collected client device data may include operational device data defining operational characteristics of the client device 110. The operational characteristics may identify a resource state characteristics corresponding to one of the client resource identifiers and defining a state of the resource kind identified by that client resource identifier. The resource state may indicate whether a resource kind present at the client device 110 is available for use in providing the emulation requested. For instance, the resource state may indicate a current usage level for the resource kind or for particular resource instances at the client device 110.

In some embodiments, the client device instructions in the access link may include request instructions for configuring the client device 110 to collect the client device data. The collected client device data may be stored for future reference in response to a selection of the access link at the client device 110. In some embodiments, the client device data may be stored locally on client device 110, while in other embodiments the collected client device data may be stored on database 140.

The request instructions generated in the access link may include storage instruction for configuring the client device 110 to store the collected client device data at a remote database such as database 140. For instance, the access link may include client device instructions for configuring the emulator application to collect client device data (e.g. on an ongoing or intermittent basis that can be done in the background on client device 110) and periodically transmit the collected client device data to the database 140. The client device instructions may also configure the client device 110 to generate the emulation request to identify the stored client device data as the client device data associated with the client device 110.

In some embodiments, the request instructions may also include data collection instructions for configuring the client device 110 to trigger collection of updated client device data at the client device 110 in response to the selection of the access link at the client device. The client device 110 may then generate the emulation request to include the updated client device data. The updated client device data may identify a change in at least one of the at least one client resource identifiers and a resource state of the at least one client resource identifiers, each resource state indicating whether a resource kind present at the client device is available for use in providing the emulation.

After generating the emulation request, emulator application 112 may provide or send the emulation request to emulation control server 122 for initiating an emulation session. In some embodiments, emulator application 112 may first send the emulation request to web server 130, which can then forward the emulation request to control server 122.

### Step 240

At 240, in response to receiving the emulation request, control server 122 can operate to create an emulation session for that emulation request. Control server 122 may create the emulation session based on the emulation data and client device data included as part of the emulation request.

When the emulation session is created, control server 122 may also create an emulation session identifier for that emulation session. Control server 122 can associate the session identifier with that emulation session. The session identifier may be unique to the emulation session being provided for client device 110. The session identifier may be stored in database 140.

### Step 250

At 250, control server 122 can determine the at least one computer product for the emulation session from computer product data associated with the emulation request. The control server 122 may determine the emulation being requested by client device 110 based on computer product identifiers included as part of the emulation request. In some cases, the emulation request may identify a location, such as an address in database 140 for identifying the computer product data used to identify the at least one computer product for the emulation session.

The control server 122 may further identify the resources required for providing the requested emulation. The resources required to provide the requested emulation that are not located on the client device 110 may be referred to as remote resources, remote resource kinds and remote resource instances. The remote resource kinds generally refer to resource kinds providable remotely from the client device 110 for the emulation session. Each remote resource kind may be providable by providing at least one corresponding remote resource instance. The control server 122 may identify the remote resource kinds required to provide the emulation session based on the client device data and the at least one computer product. The required resources can include one or more hardware and software resources.

In some embodiments, database 140 may include data defining the resource kinds required for implementing different emulations (the required resource kinds). Control server 122 may therefore determine from database 140 the resources required for providing the requested emulation. In other embodiments, the required resources kinds may be identified in the emulation request itself.

The emulation request may enable the control server 122 to identify product required resource kinds required for the emulation session using the computer product data. The control server 122 may also identify local resource kinds by identifying the resources kinds present at the client device 110 that are available for the emulation session using the operational device data. The control server 122 may then identify the remote resource kinds based on the product required resource kinds and the local resource kinds.

In embodiments where the access link is repeatedly selectable by the client device 110, the client instructions may configure the client device 110 to generate a first emulation request for initiating a first emulation session in response to a first selection of the access link, and to generate a second emulation request for initiating a second emulation session in response to a second selection of the access link. The emulation control server 122 may initiate the first emulation session using a first at least one resource instance that includes a first set of resource instances in response to the first emulation request, and initiate the second emulation session using a second at least one resource instance that includes a second set of resource instances in response to the second emulation request.

The first set of resource instances and the second set of resource instances identified by the control server 122 may be different, e.g. because the required remote resources are different, and/or because different remote resource instances are available when the emulation is requested, and/or because the emulation context has changed. In some cases, the client device data identified by the first emulation request may include a first set of client device data values and the client device data identified by the second emulation request may include a second set of client device data values that is different from the first set of client device data values. The emulation control server 122 may identify a first set of remote resource kinds required to provide the first emulation session based on the first set of client device data values and a second set of remote resource kinds required to provide the second emulation session based on the second set of client device data values. The first set of remote resource kinds and the second set of remote resource kinds may be different, e.g. if the control server 122 determines that different resources are available at the client device 110 for the emulation sessions.

### Step 260

At 260, control server 122 may select one or more emulator servers 126 to provide the identified remote resource kinds for providing the emulation. In some embodiments, control server 122 may select the one or more emulator servers 126 by determining an emulation context based on the client device data provided as part of the emulation request. For example, control server 122 may process the provided client device data—such as the authentication data, resource identifiers, operational data, geographic location, local time, etc.—to determine the emulation context.

In some embodiments, the emulation context can correspond to an appropriate class of service for the emulation session. The class of service may define a level of performance, quality of service, or priority level to be provided for the emulation session. For example, the class of service may be selected from one of class 1 service, class 2 service, and class 3 service. It will be understood that the class of service may be selected from more or fewer than three classes of service.

In some embodiments, class 1 service may define a maximum level of performance, quality, or priority for the emulation session, and may be provided to, for example, high-priority users such as users having system administrator credentials. Class 2 service may define a standard level of performance, quality, or priority for the emulation session. Class 3 service may define a minimally acceptable level of performance or quality for the emulation session. For example, class 1 service may involve prioritizing the allocation of available resources, or the highest-performance resources, of emulator system 120 to the emulation session, to provide a maximum level of performance and quality. In contrast, class 3 service may involve allocating a minimal amount of resources of emulator system 120 to meet only minimally acceptable performance and quality requirements. For example, class 3 service may involve allocating the lowest-performance resources, or only those resources that have not been allocated to other emulations sessions of class 1 or class 2 service. The performance and quality of a resource may be based on one or more of its operational characteristics such as, for example, its response time, processing speed, operational capacity, efficiency, reliability, etc.

In some examples, based on the provided client device data, control server 122 may determine there is limited network bandwidth and low data throughput between client device 110 and emulator system 120. For example, control server 122 may determine that client device 110 includes one or more low-performance network resources that results in limited data communication between client device 110 and emulator system 120. In another example, the geographic location of client device 110 or the time at which the user selected the access link may indicate that data communication between client device 110 and emulator system 120 will be limited during the emulation session.

In such cases, control server 122 may determine that, for example, network throughput is a bottleneck in the perceived performance of emulator system 120 at client device 110, and that as a result, the user will not perceive any difference in performance among class 1, class 2, and class 3 service. To optimize allocation of emulation resources, control server 122 may therefore determine that the appropriate class of service for the emulation session is class 3 service, as the user is unlikely to experience any performance benefit from client device 110 receiving class 1 or class 2 service.

On the other hand, control server 122 may determine that client device 110 has access to high-performance resources, and that as a result, the user will perceive differences in emulation performance among class 1, class 2, and class 3 service. In this case, control server 122 may determine that the appropriate class of service is, for example, class 1 service, as the user may experience an increased level of performance from client device 110 receiving class 1 service over class 2 or class 3 service.

In response to determining the emulation context, control server 122 can link the emulation context with the emulation session identifier. For example, control server 122 can store an emulation context identifier in database 140 in association with the emulation session identifier.

Control server 122 can then identify, based on the emulation context, a set of potential emulator servers 126 for providing the emulation session. For example, control server 122 may identify the set of potential emulator servers 126 by identifying emulator servers 126 having a server class designation that corresponds to the class of service defined by the emulation context.

A server class designation can correspond to a class of service that an emulator server 126 is capable of providing. For example, the server class designation may be one of a class 1 designation, class 2 designation, and class 3 designation. An emulator server 126 having a class 1 designation may be operable to provide class 1 service for the emulation session. An emulator server 126 having a class 2 designation may be operable to provide class 2 service for the emulation session. An emulator server 126 having a class 3 designation may be operable to provide class 3 service for the emulation session. The number of server class designations may correspond to the number of classes of service from which control server 122 can select to set as the emulation context.

Control server 122 may link identifiers corresponding to the set of potential emulator servers 126 with the emulation session identifier. For example, control server 122 may operate to store an emulator server identifier for each potential emulator server 126 in association with the emulation session identifier.

Control server 122 may then select one or more emulator servers 126 for providing the emulation from the set of potential emulator servers 126.

If the set of potential emulator servers 126 includes only one emulator server 126, then control server 122 may select that one emulator server 126 for providing the emulation session. If the set of potential emulator servers 126 includes more than one emulator server 126, then control server 122 may select an emulator server 126 based on balancing various factors and considerations. For example, in some embodiments, control server 122 may make the selection based on a predefined order or a default selection that may be specified in database 140. In another example, control server 122 may select an emulator server 126 by considering and balancing various operational characteristics of each potential emulator server 126 or its resources, such as computational performance, computational efficiency, availability, status, operational load, response time, geographical location, number of emulation sessions currently being provided, types of resources available, etc.

After selecting an emulator server 126, control server 122 may link identifiers corresponding to the selected emulator server 126 with the emulation session identifier. For example, control server 122 may operate to store the emulator server identifier in database 140 in association with the emulation session identifier. In some embodiments, control server 122 may select more than one emulator server 126 for providing the emulation session. In this case, emulator server 126 may link emulator server identifiers for each selected emulator server 126 with the emulation session identifier.

### Step 270

At 270, control server 122 can initiate the emulation session by instructing the selected at least one emulator server 126 to provide the requested emulation to client device 110 using the identified remote resource kinds. The at least one emulator server 126 may provide at least one corresponding remote resource instance for each identified remote resource kind on a particular emulator server 126 of the selected at least one emulator server 126.

In some embodiments, control server 122 may access database 140 to define session data for the emulation session based on the emulation session identifier. The information to be provided as part of the session data may already be linked to the relevant emulation session identifier or may not yet be linked. For example, defining session data for the emulation session may include linking stored data, such as emulation data, parameters, and identifiers, for use in initiating, providing, and managing the emulation.

In some embodiments, the session data can include the resource identifiers for identifying resources required to provide the emulation; emulation context identifiers for identifying the class of service to provide for the emulation session; emulator server identifiers for identifying the selected emulator servers 126; and emulation data defining, for example, the computer product to be emulated and properties of the emulation.

In some embodiments, control server 122 may further define the session data based on user-defined settings for the emulation or the client device data provided as part of the emulation request. The user-defined settings can be provided as part of the client device data, or may be retrieved from a user profile stored in database 140.

For example, control server 122 may determine based on the client device data that client device 110 is connected to network 150 through a mobile network, and that the user has set a preference to minimize data transmission in order to minimize mobile network costs. Control server 122 may therefore define the session data to include instructions for emulator server 126 to limit the amount of data sent to client device 110 to minimize data transmission to client device 110.

Once the session data is defined, control server 122 can proceed, based on the session data, to initiate the operation of the selected emulator server 126 to provide the requested emulation. For example, the control server 122 may operate to send an initiation request to the selected emulator server 126. The initiation request may include the emulation request and initiation parameters of the emulation corresponding to the emulation request. The initiation parameters of the emulation may include, for example, the session data defined by control server 122.

In response to receiving the initiation request, emulator server 126 may proceed to initialize the selected resources required for providing the emulation pursuant to the initiation parameters and the emulation request received from client device 110. For example, emulator server 126 may initialize resources required for providing the emulation, such as operating system components and application components. If control server 122 selected more than one emulator server 126 for providing the emulation sessions, then emulator server 126 or control server 122 may request the other emulator server 126 to initialize and make available one or more required resources for the emulation session. After the required resources are initialized, the selected emulator server 126 may operate to provide the emulation to client device 110 via emulator application 112.

It will be understood that different variations of process 200 may be provided.

The present invention has been described here by way of example only. Various modifications and variations may be made to these exemplary embodiments without departing from the spirit and scope of the invention.

1. A method for providing an emulation of a computer product, the method comprising:
receiving a link request for an access link from a client device, the link request including an identification of at least one computer product to be emulated;
generating the access link to include client device instructions for configuring a client device to, in response to a selection of the access link at the client device:
generate an emulation request for initiating an emulation session for the at least one computer product, the emulation request identifying client device data associated with the client device, the client device data including at least one client resource identifier, each client resource identifier defining a resource kind present at the client device, and the emulation request being generated to enable an emulation control server to:
determine the at least one computer product for the emulation session from computer product data associated with the emulation request;
identify remote resource kinds required to provide the emulation session based on the client device data and the at least one computer product, the remote resource kinds including at least one of a hardware resource kind and a software resource kind, the remote resource kinds being providable remotely from the client device for the emulation session by, for each remote resource kind, providing a corresponding remote resource instance;
select at least one emulator server to provide the identified remote resource kinds; and
initiate the requested emulation session by instructing the selected at least one emulator server to provide the identified remote resource kinds by providing the corresponding remote resource instance for each identified remote resource kind on a particular emulator server of the selected at least one emulator server; and
provide the emulation request to the emulation control server; and
providing the access link to the client device.

2. The method of claim 1, wherein
the access link is provided to the client device to enable repeated selection of the access link at the client device; and
the client device instructions enable the client device to generate the emulation request in response to each selection of the access link at the client device.

3. The method of claim 2, wherein the client device instructions enable the client device to
generate a first emulation request for initiating a first emulation session in response to a first selection of the access link; and
generate a second emulation request for initiating a second emulation session in response to a second selection of the access link; and
wherein
the first emulation request enables the emulation control server to initiate the first emulation session using a first at least one resource instance, the first at least one resource instance including a first set of resource instances;
the second emulation request enables the emulation control server to initiate the second emulation session using a second at least one resource instance, the second at least one resource instance including a second set of resource instances; and
the first set of resource instances and the second set of resource instances are different.

4. The method of claim 3, wherein
the client device data identified by the first emulation request includes a first set of client device data values; and
the client device data identified by the second emulation request includes a second set of client device data values, the second set of client device data values being different from the first set of client device data values.

5. The method of claim 4, wherein
the first emulation request enables the emulation control server to identify a first set of remote resource kinds required to provide the first emulation session based on the first set of client device data values;
the second emulation request enables the emulation control server to identify a second set of remote resource kinds required to provide the second emulation session based on the second set of client device data values; and
the first set of remote resource kinds and the second set of remote resource kinds are different.

6. The method of claim 2, wherein the access link is provided to the client device in a link format enabling the client device to permanently store the access link and the client device instruction at the client device to enable the repeated selection of the access link.

7. The method of claim 1, wherein the client device instructions include request instructions for configuring the client device to, in response to the selection of the access link at the client device:
trigger collection of at least some of the client device data at the client device, the at least some of the client device data that is collected identifying a resource state of at least one of the client resource identifiers, each resource state indicating whether a resource kind present at the client device is available for use in providing the emulation; and
wherein generating the emulation request comprises including the at least some of the client device data in the emulation request provided to the emulation control server.

8. The method of claim 1, wherein
the client device data includes operational device data defining operational characteristics of the client device, the operational characteristics comprising at least one resource state characteristic, each resource state characteristic corresponding to one of the client resource identifiers and defining a state of the resource kind identified by that client resource identifier; and
the emulation request enables the emulation control server to identify the remote resource kinds required to provide the emulation session by
identifying product required resource kinds required for the emulation session using the computer product data;
identifying local resource kinds by identifying the resources kinds present at the client device that are available for the emulation session using the operational device data; and
identifying the remote resource kinds based on the product required resource kinds and the local resource kinds.

9. The method of claim 1, wherein:
the client device instructions include request instructions for configuring the client device to,
collect the client device data, and
store the collected client device data; and
the emulation request identifies the stored client device data as the client device data associated with the client device.

10. The method of claim 9, wherein the request instructions include:
storage instruction for configuring the client device to store the collected client device data at a remote database; and
data collection instructions for configuring the client device to trigger collection of updated client device data at the client device, the updated client device data identifying a change in at least one of the at least one client resource identifiers and a resource state of the at least one client resource identifiers, each resource state indicating whether a resource kind present at the client device is available for use in providing the emulation.

11. The method of claim 1, further comprising:
providing a web interface including a plurality of computer product identifiers, each computer product identifier identifying a computer product that is emulatable through the emulation control server; and
wherein the at least one computer product to be emulated is identified in the link request by a selection of the computer product identifiers from the plurality of computer product identifiers, the selected computer product identifiers corresponding to the at least one computer product to be emulated.

12. The method of claim 11, further comprising:
identifying at least one of the client device and a user associated with the client device;
identifying a list of permissible computer products for the identified at least one of the client device and the user; and
wherein the plurality of computer product identifiers included in the web interface is selected from the list of permissible computer products.

13. The method of claim 1, further comprising:
authenticating at least one of the client device and a user associated with the client device prior to providing the access link to the client device.

14. A system for providing an emulation of a computer product, the system comprising:
an emulation control server for communicating with a client device over a network;
at least one emulator server coupled to the emulation control server;
wherein the emulation control server is configured to
receive a link request for an access link from the client device, the request including an identification of at least one computer product to be emulated;
generate the access link to include client device instructions for configuring the client device to, in response to a selection of the access link at the client device, generate an emulation request for initiating an emulation session for the at least one computer product, the emulation request identifying client device data associated with the client device, the client device data including at least one client resource identifier, each client resource identifier defining a resource kind present at the client device;
provide the access link to the client device over the network;
receive the emulation request from the client device in response to the selection of the access link at the client device;
determine the at least one computer product for the emulation session from computer product data associated with the emulation request;
identify remote resource kinds required to provide the emulation session based on the client device data and the at least one computer product, the resource kinds including at least one of a hardware resource kind and a software resource kind, the remote resource kinds being providable remotely from the client device for the emulation session by, for each remote resource kind, providing a corresponding remote resource instance;
select at least one emulator server to provide the identified remote resource kinds; and
initiate the requested emulation by transmitting an initiation instruction to each of the selected at least one emulator server to provide at least one particular resource kind from the identified remote resource kinds by providing the corresponding remote resource instance for that at least one particular resource kind, wherein for each emulator server of the selected at least one emulator server the initiation instruction indicates at least one particular resource kind from the identified resource kinds for that emulator server to provide; and
each emulator server is configured to provide a resource instance of the at least one particular resource kind for that emulator server to initiate the requested emulation session for the client device.

15. The system of claim 14, wherein the emulation control server is configured to:
generate the access link to enable repeated selection of the access link at the client device, and wherein the client device instructions enable the client device to generate the emulation request in response to each selection of the access link at the client device.

16. The system of claim 15, wherein the emulation control server is configured to:
receive from the client device a first emulation request for initiating a first emulation session in response to a first selection of the access link at the client device;
initiate the first emulation session using a first at least one resource instance, the first at least one resource instance including a first set of resource instances;
receive from the client device a second emulation request for initiating a second emulation session in response to a second selection of the access link at the client device; and
initiate the second emulation session using a second at least one resource instance, the second at least one resource instance including a second set of resource instances; and
wherein the first set of resource instances and the second set of resource instances are different.

17. The system of claim 16, wherein
the client device data identified by the first emulation request includes a first set of client device data values; and
the client device data identified by the second emulation request includes a second set of client device data values, the second set of client device data values being different from the first set of client device data values.

18. The system of claim 17, wherein the emulation control server is configured to:
identify a first set of remote resource kinds required to provide the first emulation session based on the first set of client device data values;
identify a second set of remote resource kinds required to provide the second emulation session based on the second set of client device data values; and
the first set of remote resource kinds and the second set of remote resource kinds are different.

19. The system of claim 14, wherein the emulation control server is configured to:
generate the access link in a link format enabling the client device to permanently store the access link.

20. The system of claim 14, wherein the emulation control server is configured to generate the access link so that the client device instructions include request instructions for configuring the client device to, in response to the selection of the access link at the client device:
trigger collection of at least some of the client device data at the client device, the at least some of the client device data that is collected identifying a resource state of at least one of the client resource identifiers, each resource state indicating whether a resource kind present at the client device is available for use in providing the emulation;
generate the emulation request to include the at least some of the client device data in the emulation request.

21. The system of claim 14, wherein
the client device data in the received emulation request includes operational device data defining operational characteristics of the client device, the operational characteristics comprising at least one resource state characteristic, each resource state characteristic corresponding to one of the client resource identifiers and defining a state of the resource kind identified by that client resource identifier; and
the emulation controller server is configured to identify the remote resource kinds required to provide the emulation session by:
identifying product required resource kinds required for the emulation session using the computer product data;
identifying local resource kinds by identifying the resources kinds present at the client device that are available for the emulation session using the operational device data; and
identifying the remote resource kinds based on the product required resource kinds and the local resource kinds.

22. The system of claim 14, wherein the emulation control server is configured to generate the access link so that the client device instructions include request instructions for configuring the client device to:
collect the client device data;
store the collected client device data; and
identify in the emulation request the stored client device data as the client device data associated with the client device.

23. The system of claim 22, wherein the emulation control server is configured to generate the access link so that the request instructions include:
storage instruction for configuring the client device to store the collected client device data at a remote database; and
data collection instructions for configuring the client device to trigger collection of updated client device data at the client device, the updated client device data identifying a change in at least one of the at least one client resource identifiers and a resource state of the at least one client resource identifiers, each resource state indicating whether a resource kind present at the client device is available for use in providing the emulation.

24. The system of claim 14, wherein the emulation control server is further configured to:
provide a web interface including a plurality of computer product identifiers, each computer product identifier identifying a computer product that is emulatable through the emulation control server; and
receive the link request using through the web interface, wherein the at least one computer product to be emulated is identified in the link request by a selection of the computer product identifiers from the plurality of computer product identifiers, the selected computer product identifiers corresponding to the at least one computer product to be emulated.

25. The system of claim 24, wherein the emulation control server is further configured to:
identify at least one of the client device and a user associated with the client device;
identify a list of permissible computer products for the identified at least one of the client device and the user; and
select the plurality of computer product identifiers to be included in the web interface from the list of permissible computer products.

26. The system of claim 14, wherein the emulation control server is further configured to authenticate at least one of the client device and a user associated with the client device prior to providing the access link to the client device.

27. A non-transitory computer-readable storage medium having stored thereon a plurality of instructions are stored, the instructions for configuring a processor to perform a method of providing an emulation of a computer product, the method comprising:
receiving a link request for an access link from a client device, the link request including an identification of at least one computer product to be emulated;
generating the access link to include client device instructions for configuring a client device to, in response to a selection of the access link at the client device:
generate an emulation request for initiating an emulation session for the at least one computer product, the emulation request identifying client device data associated with the client device, the client device data including at least one client resource identifier, each client resource identifier defining a resource kind present at the client device, and the emulation request being generated to enable an emulation control server to:
determine the at least one computer product for the emulation session from computer product data associated with the emulation request;
identify remote resource kinds required to provide the emulation session based on the client device data and the at least one computer product, the remote resource kinds including at least one of a hardware resource kind and a software resource kind, the remote resource kinds being providable remotely from the client device for the emulation session by, for each remote resource kind, providing a corresponding remote resource instance;
select at least one emulator server to provide the identified remote resource kinds; and
initiate the requested emulation session by instructing the selected at least one emulator server to provide the identified remote resource kinds by providing the corresponding remote resource instance for each identified remote resource kind on a particular emulator server of the selected at least one emulator server; and
provide the emulation request to the emulation control server; and
providing the access link to the client device.
